(19) United States
(12) Patent Application Publication
(10) Pub. No.: US 2019/0132515 A1
(43) Pub. Date: May 2, 2019

(54) Gyro Sensor Apparatus, Attitude Control System, And Camera Apparatus

(71) Applicant: Seiko Epson Corporation, Tokyo (JP)

(72) Inventors: Hideo HANEDA, Matsumoto (JP); Katsuhiko MAKI, Chino (JP)

(21) Appl. No.: 16/174,750

(22) Filed: Oct. 30, 2018

(30) Foreign Application Priority Data
Oct. 31, 2017 (JP) 2017-211286

(51) Int. Cl. H04N 5/232; G01C 19/5776; G01P 3/22

(52) U.S. Cl. CPC H04N 5/23258; G01C 19/5776; H04N 5/23267; H04N 5/23287; G01P 3/22

(57) ABSTRACT

A gyro sensor apparatus includes a sensor device that outputs a detection signal, a control circuit including an angular velocity detection circuit that detects angular velocity based on the detection signal, an angle calculation circuit that calculates an angle based on the angular velocity, and an actuator drive signal generation circuit that generates an actuator drive signal based on the angle, a base body that supports the sensor device and the control circuit, and an output terminal that is provided as part of the base body and outputs the actuator drive signal or a signal based thereon.

### CROSS-REFERENCE

The entire disclosure of Japanese Patent Application No. 2017-211286, filed Oct. 31, 2017 is expressly incorporated by reference herein.

### BACKGROUND

### 1. Technical Field

The present invention relates to a gyro sensor apparatus, an attitude control system, and a camera apparatus.

### 2. Related Art

There has been a known system that controls the attitude of a target object by using a result of detection performed by a gyro sensor that detects angular velocity. For example, a ship radar apparatus described in JP-A-2012-107968 includes a radar antenna, a rotational action apparatus that causes the radar antenna to rotate, a support that supports the radar antenna and the rotational action apparatus, an angular velocity sensor provided on the support, and a controller (digital signal processor: DSP) that controls the attitude of the support based on a detection signal from the angular velocity sensor.

The ship radar apparatus described in JP-A-2012-107968, in which the angular velocity sensor and the controller (DSP) are components separate from each other, requires a communication circuit that allows the angular velocity sensor and the controller to communicate with each other. In the ship radar apparatus described in JP-A-2012-107968, the control responsiveness cannot therefore be increased due to restriction imposed by the time required for the communication, and appropriate attitude control cannot be performed in some cases.

### SUMMARY

An advantage of some aspects of the invention is to provide a gyro sensor apparatus and an attitude control system capable of improving control responsiveness and a camera apparatus including the attitude control system.

The invention can be implemented as the following forms or application examples.

A gyro sensor apparatus according to an application example of the invention includes a sensor device that outputs a detection signal, a control circuit including an angular velocity detection circuit that detects angular velocity based on the detection signal, an angle calculation circuit that calculates an angle based on the angular velocity, and an actuator drive signal generation circuit that generates the angle an actuator drive signal based on the angle, the actuator drive signal being usable to control an actuator drive circuit that drives an actuator, a base body that supports the sensor device and the control circuit, and an output terminal that is provided as part of the base body and outputs the actuator drive signal or a signal based on the actuator drive signal.

According to the gyro sensor apparatus described above, in which the control circuit includes the angular velocity detection circuit, the angle calculation circuit, and the actuator drive signal generation circuit, the actuator drive signal can be generated based on high-speed signal processing with no communication circuit interposed among the circuits. The control responsiveness in a system using the gyro sensor apparatus can therefore be increased. Further, since the control circuit is supported by the base body, by which the sensor device is supported, the circuits provided in the control circuit can be readily integrated into a single chip with no communication circuit, whereby the configuration of the gyro sensor apparatus can also be simplified.

In the gyro sensor apparatus according to the application example, it is preferable that an operation frequency of the angle calculation circuit is equal to an operation frequency of the actuator drive signal generation circuit.

High-speed signal processing between the angle calculation circuit and the actuator drive signal generation circuit can therefore be achieved in a relatively simple configuration.

In the gyro sensor apparatus according to the application example, it is preferable that the actuator is a rotational stepper motor.

The gyro sensor apparatus can therefore be used to control the drive operation of the rotational stepper motor.

In the gyro sensor apparatus according to the application example, it is preferable that the actuator is a DC motor or an AC motor.

The gyro sensor apparatus can therefore be used to control the drive operation of the DC motor or the AC motor.

It is preferable that the gyro sensor apparatus according to the application example further includes an input terminal to which control information used to control the actuator is inputted, and a storage section that stores the control information, and that the actuator drive signal generation circuit uses the control information to generate the actuator drive signal.

The type of the actuator controllable by the gyro sensor apparatus can therefore be changed based on the control information inputted to the input terminal.

In the gyro sensor apparatus according to the application example, it is preferable that the control circuit further includes an extraction section that extracts angular velocity that belongs to a partial frequency band from the angular velocity detected by the angular velocity detection circuit.

High-precision control in a desired frequency band (frequency band suitable for hand-shake correction, for example) can thus be performed.

In the gyro sensor apparatus according to the application example, it is preferable that the control circuit further includes an abnormality detection section that detects abnormality in an operation state of the actuator based on the detection signal.

The convenience of a system using the gyro sensor apparatus can thus be improved.

In the gyro sensor apparatus according to the application example, it is preferable that the control circuit further includes the actuator drive circuit.

The convenience of the gyro sensor apparatus can thus be improved.

An attitude control system according to another application example of the invention includes the gyro sensor apparatus according to the application example described above and an actuator controlled and driven by the gyro sensor apparatus.

According to the thus configured attitude control system, the responsiveness of the attitude control can be improved.

A camera apparatus according to another application example of the invention includes the gyro sensor apparatus according to the application example described above, an actuator controlled and driven by the gyro sensor apparatus, and an imaging section an attitude of which is changed by the actuator relative to a support member.

According to the thus configured camera apparatus, excellent image shake correction can be achieved.

In the camera apparatus according to the application example, it is preferable that the imaging section includes an imaging device that outputs captured image data, and that the camera apparatus further includes an image processor that processes the captured image data by using a signal from the gyro sensor apparatus.

The performance of image shake correction can thus be further enhanced.

### BRIEF DESCRIPTION OF THE DRAWINGS

The invention will be described with reference to the accompanying drawings, wherein like numbers reference like elements.

FIG. 1 is a plan view showing a schematic configuration of a gyro sensor apparatus according to an embodiment of the invention.

FIG. 2 is a cross-sectional view taken along the line A-A in FIG. 1.

FIG. 3 is a plan view of a device element of a sensor device provided in the gyro sensor apparatus shown in FIG. 1.

FIG. 4 is a block diagram of a control circuit provided in the gyro sensor apparatus shown in FIG. 1.

FIG. 5 is a block diagram showing key parts of the control circuit shown in FIG. 4.

FIG. 6 is a block diagram showing key parts of a control circuit provided in a gyro sensor apparatus according to Variation 1.

FIG. 7 is a block diagram of a control circuit provided in a gyro sensor apparatus according to Variation 2.

FIG. 8 is a conceptual diagram showing Example 1 of the configuration of an attitude control system including the gyro sensor apparatus according to the embodiment of the invention.

FIG. 9 is a conceptual diagram showing Example 2 of the configuration of the attitude control system including the gyro sensor apparatus according to the embodiment of the invention.

FIG. 10 is a conceptual diagram showing Example 3 of the configuration of the attitude control system including the gyro sensor apparatus according to the embodiment of the invention.

FIG. 11 is a conceptual diagram showing Example 4 of the configuration of the attitude control system including the gyro sensor apparatus according to the embodiment of the invention.

FIG. 12 is a schematic view showing an example of the configuration of a camera apparatus including the gyro sensor apparatus according to the embodiment of the invention.

### DESCRIPTION OF EXEMPLARY EMBODIMENTS

A gyro sensor apparatus, an attitude control system, and a camera apparatus according to embodiments of the invention will be described below in detail with reference to the accompanying drawings.

### 1. Gyro Sensor Apparatus

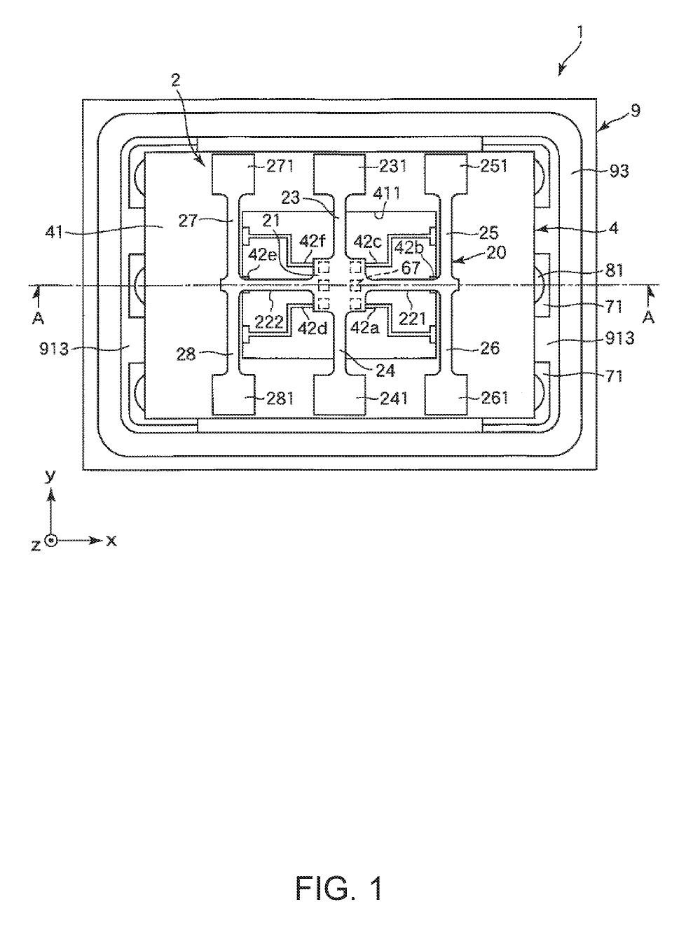

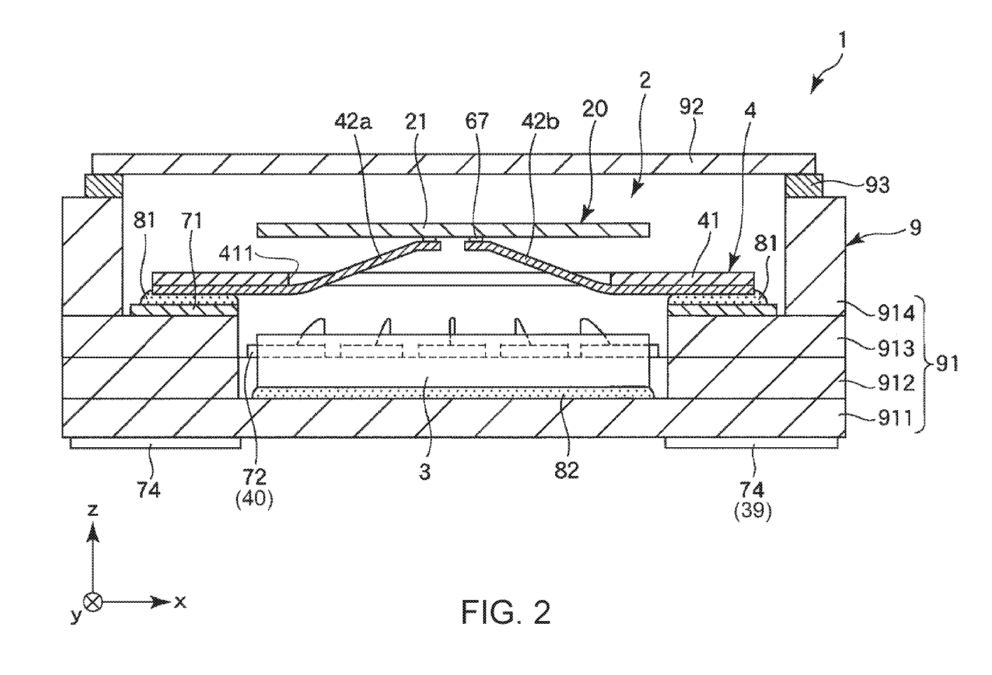

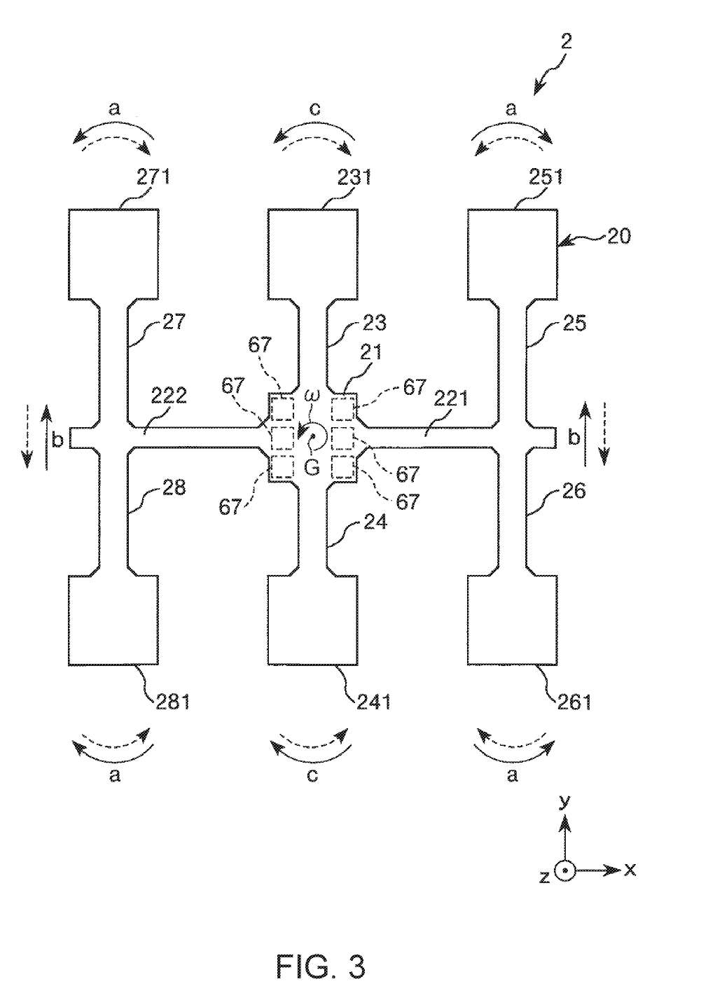

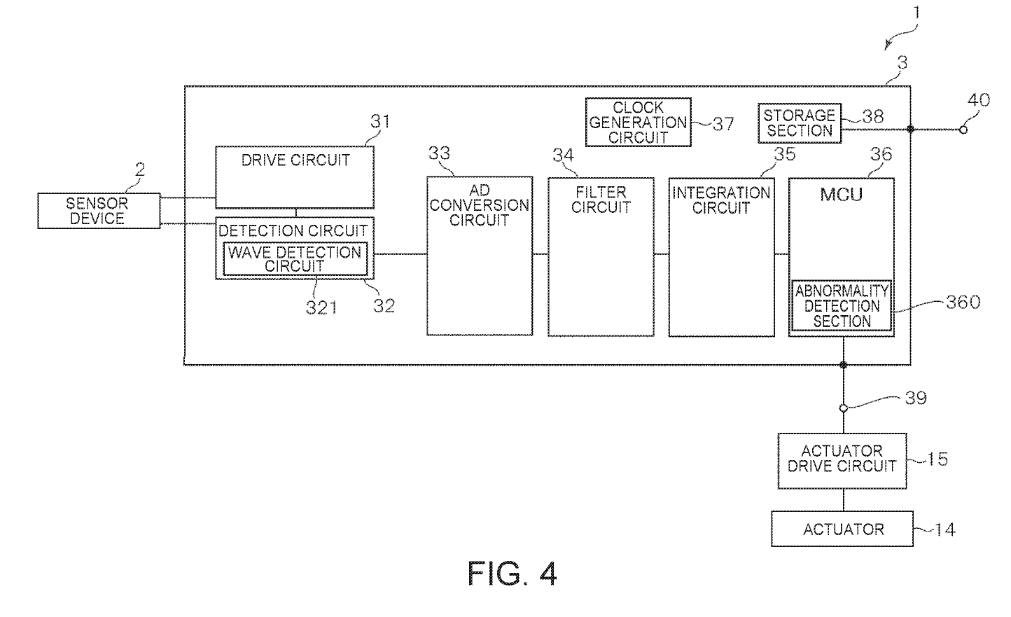

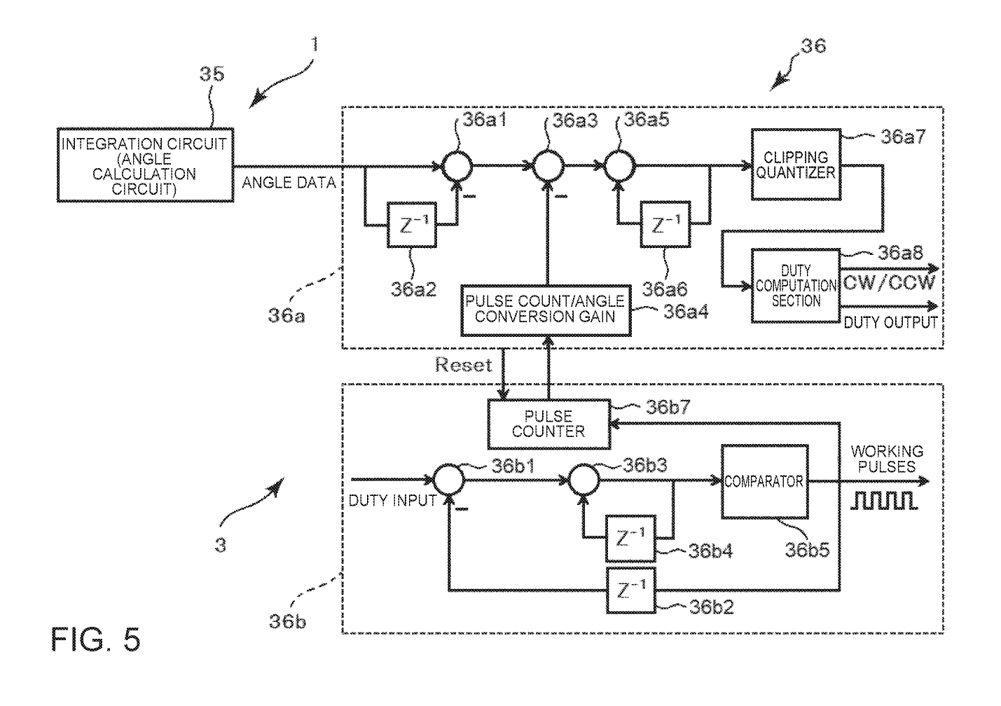

FIG. 1 is a plan view showing a schematic configuration of a gyro sensor apparatus according to an embodiment of the invention. FIG. 2 is a cross-sectional view taken along the line A-A in FIG. 1. FIG. 3 is a plan view of a device element of a sensor device provided in the gyro sensor apparatus shown in FIG. 1. FIG. 4 is a block diagram of a control circuit provided in the gyro sensor apparatus shown in FIG. 1. FIG. 5 is a block diagram showing key parts of the control circuit shown in FIG. 4.

In the following description, an x axis, a y axis, and a z axis that are three axes perpendicular to one another are used as appropriate for ease of description. Further, in the following description, the direction parallel to the x axis is called an “x-axis direction,” the direction parallel to the y axis is called a “y-axis direction,” and the direction parallel to the z axis is called a “z-axis direction.” Moreover, in the following description, the tip end side of an arrow representing each of the x, y, and z axes is assumed to be “+”, and the base side of the arrow is assumed to be “−”. Further, the upper side in FIG. 2 (+z-axis-direction side) is called “upper,” and the lower side (−z-axis-direction side) is called “lower.” In FIG. 1, a lid 92, which will be described later, is omitted for ease of description.

A gyro sensor apparatus 1 shown in FIGS. 1 and 2 is used in combination with an actuator 14, such as a motor, and an actuator drive circuit 15, which drives the actuator 14, and has the function of detecting angular velocity around the z axis and the function of controlling the drive operation of the actuator drive circuit 15 based on the result of the detection. The gyro sensor apparatus 1 includes a sensor device 2, which includes a device element (sensor device element) and a support member 4, an IC chip 3 (integrated circuit chip), and a package 9, which accommodates the sensor device 2 and the IC chip 3. The portions that form the gyro sensor apparatus 1 will be sequentially described below.

### Sensor Device

The sensor device 2 is an “out-of-plane detection” vibration gyro sensor device that detects angular velocity around the z axis. The sensor device 2 includes the device element 20 and the support member 4, which supports the device element 20, as shown in FIGS. 1 and 2.

The device element 20 has what is called a double-T structure, as shown in FIG. 3. In a specific description, the device element 20 includes a base section 21, a pair of detection vibration arms 23 and 24 and a pair of linkage arms 221 and 222, which extend from the base section 21, a pair of drive vibration arms 25 and 26, which extend from the linkage arm 221, and a pair of drive vibration arms 27 and 28, which extend from the linkage arm 222.

The detection vibration arms 23 and 24 extend from the base section 21 in opposite directions along the y-axis direction. The drive vibration arms 25 and 26 extend from a tip end portion of the linkage arm 221 in opposite directions along the y-axis direction. Similarly, the drive vibration arms 27 and 28 extend from a tip end portion of the linkage arm 222 in opposite directions along the y-axis direction.

In the present embodiment, the tip end of the detection vibration arm 23 is provided with a weight (hammer head) 231, which is wider than the base portion of the detection vibration arm 23. Similarly, the tip end of the detection vibration arm 24 is provided with a weight 241, the tip end of the drive vibration arm 25 is provided with a weight 251, the tip end of the drive vibration arm 26 is provided with a weight 261, the tip end of the drive vibration arm 27 is provided with a weight 271, and the tip end of the drive vibration arm 28 is provided with a weight 281. Providing the weights allows reduction in size of the sensor device element 2 and improvement in the detection sensitivity thereof.

In the present embodiment, the device element 20 is made of a piezoelectric material. Examples of the piezoelectric material may include quartz crystal, lithium tantalate, lithium niobate, lithium borate, and barium titanate. Quartz crystal (Z cut plate) is particularly preferable as the piezoelectric material that forms the device element 20. The device element 20 made of quartz crystal allows excellent vibration characteristics (frequency-temperature characteristic, in particular). Further, the device element 20 can be formed with high dimensional precision in an etching process.

The drive vibration arms 25, 26, 27, and 28 of the thus configured device element 20 are each provided, although not shown, with a pair of drive electrodes (drive signal electrode and drive ground electrode) that cause the corresponding one of the drive vibration arms 25, 26, 27, and 28 to undergo flexural vibration in the x-axis direction when current flows through the pair of drive electrodes.

The detection vibration arms 23 and 24 of the device element 20 are each provided, although not shown, with a pair of detection electrodes (detection signal electrode and detection ground electrode) that detect electric charge produced in association with x-axis-direction flexural vibration of the corresponding one of the detection vibration arms 23 and 24.

The base section 21 is provided with a plurality of terminals 67. The plurality of terminals 67 are electrically connected to the detection electrodes provided on the detection vibration arms 23 and 24 and the drive electrodes provided on the drive vibration arms 25 to 28 described above via wiring lines that are not shown.

The drive electrodes, the detection electrodes, and the terminals 67 are not each necessarily made of a specific material and can be made, for example, of gold (Au), a gold alloy, platinum (Pt), aluminum (Al), an aluminum alloy, silver (Ag), a silver alloy, chromium (Cr), a chromium alloy, copper (Cu), molybdenum (Mo), niobium (Nb), tungsten (W), iron (Fe), titanium (Ti), cobalt (Co), zinc (Zn), zirconium (Zr), or any other metal material, or ITO, ZnO, or any other transparent electrode material. Among the materials described above, a metal primarily containing gold (gold, gold alloy) or platinum is preferably used.

A layer made, for example, of Ti or Cr may be provided as an undercoat layer between the device element 20 and the drive electrodes and the like, and the undercoat layer has the function of preventing the drive electrodes and the like from separating off the device element 20. The drive electrodes and the like can be formed together in a single film formation step.

The thus formed device element 20 is supported by the package 9 via the support member 4 for tape automated bonding (TAB) implementation in the base section 21. The support member 4 includes an insulating film 41, which is made of polyimide or any other resin material, and a plurality of wiring lines 42, which are made of copper or any other metal material and bonded onto one surface of the film 41 (lower side thereof in FIG. 2), as shown in FIG. 2. The plurality of wiring lines 42 are provided in correspondence with the plurality of terminals 67 provided on the device element 20 described above. A device hole 411 is formed in a central portion of the film 41, and the wiring lines 42 extend on the film 41 toward the device hole 411, and the wiring lines 42 that extend off the edge of the device hole 411 are folded toward the film 41 (upper side thereof). The tip end of each of the wiring lines 42 is connected and fixed to the corresponding terminal 67 via a metal bump or any other bonding material that is not shown. As a result, the drive electrodes and the detection electrodes are electrically connected to the terminals 67, and the device element 20 is supported by the support member 4.

The thus configured sensor device 2 detects angular velocity ω around the z axis as follows: First, voltage (drive signal) is applied across each of the pairs of drive electrodes to cause the drive vibration arms 25 and 27 to undergo flexural vibration (drive vibration) in the direction indicated by arrows a in FIG. 3 in such a way that the drive vibration arms 25 and 27 approach each other and move away from each other and the drive vibration arms 26 and 28 to undergo flexural vibration (drive vibration) in the same direction of the flexural vibration of the drive vibration arms 25 and 27 in such a way that the drive vibration arms 26 and 28 approach each other and move away from each other. In a case where no angular velocity acts on the sensor device 2 during the flexural vibration, the base section 21, the linkage arms 221 and 222, or the detection vibration arms 23 and 24 hardly vibrate because the drive vibration arms 25 and 26 and the drive vibration arms 27 and 28 undergo symmetric vibration with respect to the yz plane passing through the center point (center of gravity G).

When the angular velocity ω around the normal passing through the center of gravity of the sensor device 2 (that is, around z axis) acts on the sensor device 2 with the drive vibration arms 25 to 28 undergoing the drive vibration (operating in drive mode), Coriolis force acts on each of the drive vibration arms 25 to 28. The linkage arms 221 and 222 then undergo flexural vibration in the direction indicated by arrows b in FIG. 3. In response to the flexural vibration of the linkage arms 221 and 222, the detection vibration arms 23 and 24 are so excited as to undergo flexural vibration (detection vibration) in the direction indicated by arrows c in FIG. 3 in such a way that the two types of flexural vibration cancel out. The detection vibration of the detection vibration arms 23 and 24 (detection mode) produces electric charge between the pair of detection electrodes, and detection signals are outputted from the detection signal electrodes. The angular velocity ω acting on the sensor device 2 can be determined based on the detection signals.

### IC Chip

The IC chip 3 (control circuit) shown in FIG. 2 is an electronic part having the function of generating a drive signal inputted to the sensor device 2 described above the function of detecting the angular velocity based on a detection signal from the sensor device 2 and the function of controlling the drive operation of the actuator drive circuit 15 based on the detected angular velocity. The IC chip 3 includes a drive circuit 31, a detection circuit 32 (angular velocity detection circuit), an AD conversion circuit 33, a filter circuit 34 (extraction section), an integration circuit 35 (angle calculation circuit), a micro control unit (MCU) 36 (actuator drive signal generation circuit), a clock generation circuit 37, and a storage section 38, as shown in FIG. 4.

The drive circuit 31 includes, although not shown, for example, an oscillation circuit and an automatic gain control circuit, and the automatic gain control circuit adjusts the gain for a drive signal generated by the oscillation circuit. The resultant drive signal is inputted to the drive signal electrodes of the sensor device 2 to cause the sensor device 2 to undergo drive vibration.

The detection circuit 32 (angular velocity detection circuit) includes a wave detection circuit 321, which is a synchronized wave detection circuit. More specifically, although not shown, the detection circuit 32 includes, for example, a current-voltage conversion amplifier, an AC amplifier, and a 90-degree phase shifter as well as the wave detection circuit 321. In the thus configured detection circuit 32, the current-voltage conversion amplifier converts each of the detection signals outputted from the detection signal electrodes of the sensor device 2 from a current signal to a voltage signal, which is amplified by the AC amplifier and inputted to the wave detection circuit 321. The drive signal from the drive circuit 31 described above is inputted to also the wave detection circuit 321 via the 90-degree phase shifter. The wave detection circuit 321 then performs synchronized wave detection by using the drive signal as a reference signal to extract angular velocity information from the detection signals and outputs the angular velocity information as a wave detection signal. The detection circuit 32 thus detects the angular velocity based on the detection signals from the sensor device 2.

The AD conversion circuit 33 converts the wave detection signal (angular velocity information) from the wave detection circuit 321 described above from an analog signal to a digital signal and outputs the digital signal.

The filter circuit 34 (extraction section) is, for example, a high-pass filter, removes or reduces components that belong to a low-frequency band lower than a desired frequency band from the digital signal from the AC conversion circuit 33, extracts a signal containing angular velocity information that belongs to the desired frequency band, and outputs the signal.

The integration circuit 35 (angle calculation circuit) integrates the signal (angular velocity information) from the filter circuit 34 over time to generate a signal of angle information and outputs the signal.

The MCU 36 (actuator drive signal generation circuit) includes, although not shown, for example, a processor, such as a central processing unit (CPU), and a memory, such as a read only memory (ROM) and a random access memory (RAM), and the processor executes a program stored in the memory to achieve a variety of functions described below.

The MCU 36 has the function of generating an actuator drive signal that controls the drive operation of the actuator drive circuit 15 based on the signal (angle information) from the integration circuit 35. The MCU 36 further has the function of detecting abnormality in the control of the actuator 14 (abnormality detection section 360) based on the signal (angle information) from the integration circuit 35.

The actuator drive signal generated by the MCU 36 is set in accordance with the type of the actuator drive circuit 15. In a case where the actuator 14 is a stepper motor, although the actuator 14 is not a specific component, the MCU 36 is configured, for example, as shown in FIG. 5.

The MCU 36 shown in FIG. 5 is divided into two regions, a region 36a, where the MCU 36 operates at the same operation frequency of the integration circuit 35, and a region 36b, where the MCU 36 operates at the speed of an actuator drive signal (working pulses) for the stepper motor. The region 36a includes a subtractor 36a1, a delay circuit 36a2, a subtractor 36a3, a pulse count/angle conversion gain 36a4, an adder 36a5, a clipping quantizer 36a7, and a duty computation section 36a8. The region 36b includes a subtractor 36b1, a delay circuit 36b2, an adder 36b3, a delay circuit 36b4, a comparator 36b5, and a pulse counter 36b7.

The subtractor 36a1 subtracts data outputted from the delay circuit 36a2 from the angle data from the integration circuit 35 and outputs the result of the subtraction to the subtractor 36a3. The subtractor 36a1 and the delay circuit 36a2 form a differentiator. The subtractor 36a3 subtracts data outputted from the pulse count/angle conversion gain 36a4 from the data outputted from the subtractor 36a1 and outputs the result of the subtraction to the adder 36a5. The pulse count/angle conversion gain 36a4 outputs data on gain for converting the pulse count into an angle. The adder 36a5 adds the data outputted from the subtractor 36a3 to data outputted from the delay circuit 36a6 and outputs the result of the addition to the clipping quantizer 36a7. The adder 36a5 and the delay circuit 36a6 form an integrator. The clipping quantizer 36a7 quantizes the data outputted from the adder 36a5 at a predetermined quantization step and outputs the result of the quantization to the duty computation section 36a8. The duty computation section 36a8 computes a duty ratio based on the data outputted from the clipping quantizer 36a7 and outputs the result of the computation to the subtractor 36b1 in the region 36b.

The subtractor 36b1 subtracts data outputted from the delay circuit 36b2 from the data outputted from the duty computation section 36a8 (duty) and outputs the result of the subtraction to the adder 36b3. The adder 36b3 adds the data outputted from the subtractor 36b1 to data outputted from the delay circuit 36b4 and outputs the result of the addition to the comparator 36b5. The adder 36b3 and the delay circuit 36b4 form an integrator. The comparator 36b5 compares the data outputted from the adder 36b3 with reference data and outputs the actuator drive signal (working pulses) when the outputted compared data shows a high level (greater than reference data). The actuator drive signal (working pulses) is also inputted to the delay circuit 36b2 and the pulse counter 36b7. The pulse counter 36b7 counts the pulses that form the actuator drive signal (working pulses) and outputs the result of the counting to the pulse count/angle conversion gain in the region 36a.

The clock generation circuit 37 shown in FIG. 4 generates a clock signal for operation of each portion in the IC chip 3 (control circuit) based on a signal from an oscillator that is not shown, such as a quartz crystal oscillator. Each portion in the IC chip 3 operates in synchronization with the clock signal.

The storage section 38 is, for example, a rewritable memory and stores control information used to control the actuator 14. The information stored in the storage section 38 can be rewritten via an input terminal 40. The control information is formed of a variety of pieces of information used by the gyro sensor apparatus 1 to control the drive operation of the actuator 14 or the actuator drive circuit 15 and contains, for example, a target value (set angle, for example) of the control, control conditions, and a control program. The storage section 38 can store at least part of the control information. The MCU 36 can read the information stored in the storage section 38 as appropriate and use the read information (execute program, for example).

The drive circuit 31, the detection circuit 32, the AD conversion circuit 33, the filter circuit 34, the integration circuit 35, the MCU 36, the clock generation circuit 37, and the storage section 38 described above are not necessarily provided in a single IC chip but may be allocated, for example, to a plurality of IC chips.

### Package

The package 9 shown in FIGS. 1 and 2 accommodates the sensor device 2 (device element 20 and support member 4) and the IC chip 3 (integrated circuit chip).

The package 9 includes a base 91, which serves as a base body having a recess that opens upward, and the lid (lid body), which is so bonded to the base 91 via a bonding member 93 (seal ring) that the lid 82 closes the opening of the recess of the base 91.

The base 91 is formed of a flat-plate-shaped substrate 911, a frame-shaped substrate 912, which is bonded to the upper surface of the substrate 911, a frame-shaped substrate 913, which is bonded to the upper surface of the substrate 912, and a frame-shaped substrate 914, which is bonded to the upper surface of the substrate 913. The recess of the base 91 thus has stepped portions between the substrates 911, 912, 913, and 914. The material of which the thus shaped base 91 is made (material of which each of substrates 911 to 914 is made) is not limited to a specific material and can, for example, be any of a variety of ceramic materials, such as an aluminum oxide.

The IC chip 3 is supported by and fixed to the upper surface of the substrate 911 of the base 91 via a fixing member 82, which is, for example, an adhesive containing an epoxy resin, an acrylic resin, or any other resin material in such a way that the IC chip 3 is accommodated in the opening formed by the substrates 912 and 913.

A plurality of inner terminals 72 are provided on the upper surface of the substrate 912. A plurality of inner terminals 71 are provided on the upper surface of the substrate 913.

The plurality of inner terminals 71 are electrically connected to the corresponding inner terminals 72 via wiring lines (not shown) provided in the base 91. The base portions of the wiring lines 42 of the support member 4 described above are bonded to the plurality of inner terminals 71 via a fixing member 81. The device element 20 is thus supported by the base 91 via the support member 4. The fixing member 81 is formed, for example, of solder, silver paste, or an electrically conductive adhesive (adhesive in which electrically conductive fillers, such as metal particles, are dispersed in resin material). The plurality of inner terminals 71 are thus electrically connected to the plurality of wiring lines 42 of the support member 4 via the fixing member 81.

The IC chip 3 described above is electrically connected to the plurality of inner terminals 72 via wiring lines formed, for example, of bonding wires.

A plurality of outer terminals 74, which are used when the gyro sensor apparatus 1 is implemented in an instrument in which the gyro sensor apparatus 1 is assembled (external instrument), are provided on the lower surface of the substrate 911 (side opposite sensor device 2) of the base 91. The plurality of outer terminals 74 are electrically connected to the corresponding inner terminals 72 via inner wiring lines that are not shown. The outer terminals 74 are thus electrically connected to the IC chip 3. The plurality of outer terminals 74 include the output terminal 39 and the input terminal 40 described above.

The thus formed inner terminals 71 and 72, outer terminals 74, and other terminals are each formed, for example, of a metal coating that is a laminate in which a coating made, for example, of nickel (Ni) or gold (Au) is laminated on a metalized layer made, for example, of tungsten (W) by plating or other means.

The lid 92 is hermetically bonded to the thus configured base 91 via the bonding member 93. The package 9 is thus hermetically sealed. The lid 92 and the bonding member 93 are each made, for example, of Kovar, 42 alloy, stainless steel, or any other metal.

The bonding between the base 91 and the lid 92 is performed, for example, by using seam welding or welding using a laser beam or any other energy ray.

The gyro sensor apparatus 1 described above includes the sensor device 2, which outputs the detection signal, the IC chip 3, which forms the control circuit, the base 91, which is the base body that supports the sensor device 2 and the IC chip 3, and the output terminal 39, which is provided as part of the base 91 and outputs the actuator drive signal or a signal based thereon (actuator drive signal in present embodiment). The IC chip 3 (control circuit) includes the detection circuit 32, which is an angular velocity detection circuit that detects angular velocity based on the detection signal from the sensor device 2, the integration circuit 35, which is an angle calculation circuit that calculates an angle based on the angular velocity detected by the detection circuit 32, and the MCU 36, which is the actuator drive signal generation circuit that generates the actuator drive signal based on the angle calculated by the integration circuit 35. The actuator drive signal can be used to control the actuator drive circuit 15, which drives the actuator 14.

According to the gyro sensor apparatus 1 described above, in which the IC chip 3 includes the detection circuit 32, the integration circuit 35, and the MCU 36, the actuator drive signal can be generated based on high-speed signal processing with no communication circuit interposed among the detection circuit 32, the integration circuit 35, and the MCU 36. The control responsiveness in a system using the gyro sensor apparatus 1 can therefore be increased. Further, since the IC chip 3 is supported by the base 91, by which the sensor device 2 is supported, the circuits provided in the IC chip 3 can be readily integrated into a single chip with no communication circuit, whereby the configuration of the gyro sensor apparatus 1 can also be simplified.

The operation frequency of the integration circuit (angle calculation circuit) is equal to the operation frequency of the MCU 36 (actuator drive signal generation circuit). High-speed signal processing between the integration circuit 35 and the MCU 36 can therefore be achieved in a relatively simple configuration.

In the present embodiment, the actuator 14 is a rotational stepper motor. The gyro sensor apparatus 1 can therefore be used to control the drive operation of the actuator 14, which is a rotational stepper motor.

The gyro sensor apparatus 1 further includes the input terminal 40, to which the control information used to control the actuator 14 is inputted, and the storage section 38, which stores the control information, and the MCU 36 (actuator drive signal generation circuit) uses the control information to generate the actuator drive signal. The type of the actuator 14 controllable by the gyro sensor apparatus 1 can therefore be changed based on the control information inputted to the input terminal 40.

Further, in the gyro sensor apparatus 1, the IC chip 3 (control circuit) includes the filter circuit 34, which is the extraction section that extracts angular velocity that belongs to a partial frequency band from the angular velocity detected by the detection circuit 32 (angular velocity detection circuit). High-precision control in a desired frequency band (frequency band suitable for hand-shake correction, for example) can thus be performed.

The IC chip 3 (control circuit) further includes the abnormality detection section 360, which detects abnormality in the operation state of the actuator 14 based on the detection signal from the sensor device 2. The convenience of a system using the gyro sensor apparatus 1 can thus be improved.

### Variation 1

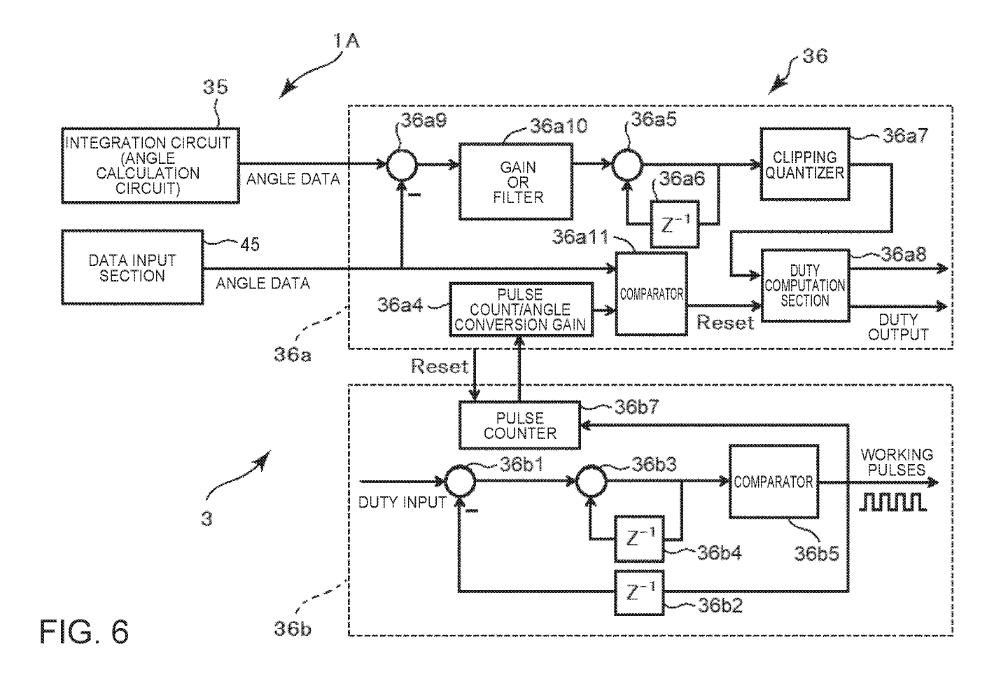

FIG. 6 is a block diagram showing key parts of a control circuit provided in a gyro sensor apparatus according to Variation 1.

Variation 1 will be described below primarily on differences from the embodiment described above, and no description of similar items will be made. Components similar to those in the embodiment described above have the same reference characters.

In a gyro sensor apparatus 1A according to Variation 1, the region 36a of the MCU 36 includes, for example, a subtractor 36a9, a gain 36a10 (or filter), a comparator 36a11, the pulse count/angle conversion gain 36a4, the adder 36a5, the clipping quantizer 36a7, and the duty computation section 36a8, as shown in FIG. 6.

The subtractor 36a9 subtracts angle data inputted from a data input section 45 from the angle data from the integration circuit 35 and outputs the result of the subtraction to the gain 36a10.

The gain 36a10 amplifies data outputted from the subtractor 36a9 and outputs the amplified data to the adder 36a5. The adder 36a5, the clipping quantizer 36a7, and the duty computation section 36a8 then operate in the same manner as in the embodiment described above and input data on the duty ratio to the subtractor 36b1 in the region 36b.

As described above, the gyro sensor apparatus 1A includes the data input section 45 for setting a rotational angle of the actuator 14, and the MCU 36 (actuator drive signal generation circuit) compares the angle data from the data input section 45 with information based on the actuator drive signal (pulse count/angle conversion gain 36a4) and produces information on the result of the comparison. The thus produced information can be used, for example, to control the rotational angle of the actuator 14 to be a set value.

The gyro sensor apparatus 1A described above can also provide the same effects as those provided by the gyro sensor apparatus 1 described above.

### Variation 2

FIG. 7 is a block diagram of a control circuit provided in a gyro sensor apparatus according to Variation 2. Variation 2 will be described below primarily on differences from the embodiment described above, and no description of similar items will be made. Components similar to those in the embodiment described above have the same reference characters.

A gyro sensor apparatus 1B according to Variation 2 is the same as the gyro sensor apparatus 1 described above except that the IC chip 3 (control circuit) includes the actuator drive circuit 15. The gyro sensor apparatus 1B outputs, as the signal based on the actuator drive signal, a signal from the actuator drive circuit 15 (drive electric power) to the actuator 14 via an output terminal 39B.

The IC chip 3 (control circuit) includes the actuator drive circuit 15, as described above. The convenience of the gyro sensor apparatus 1B can thus be improved.

The actuator drive circuit 15 is designed as appropriate in accordance with the type of the actuator 14. For example, in a case where the actuator 14 is a DC motor or an AC motor, the actuator drive circuit 15 can be a circuit that drives a DC motor or an AC motor. The gyro sensor apparatus 1B can then be used to control the drive operation of the DC motor or the AC motor.

The gyro sensor apparatus 1B described above can also provide the same effects as those provided by the gyro sensor apparatus 1 described above.

### 2. Attitude Control System

Examples 1 to 4 of the configuration of an attitude control system including the gyro sensor apparatus 1 described above will be described below as the attitude control system according to an embodiment of the invention. In the following description, differences from the embodiment described above will be primarily described, and no description of similar items will be made.

### Configuration Example 1

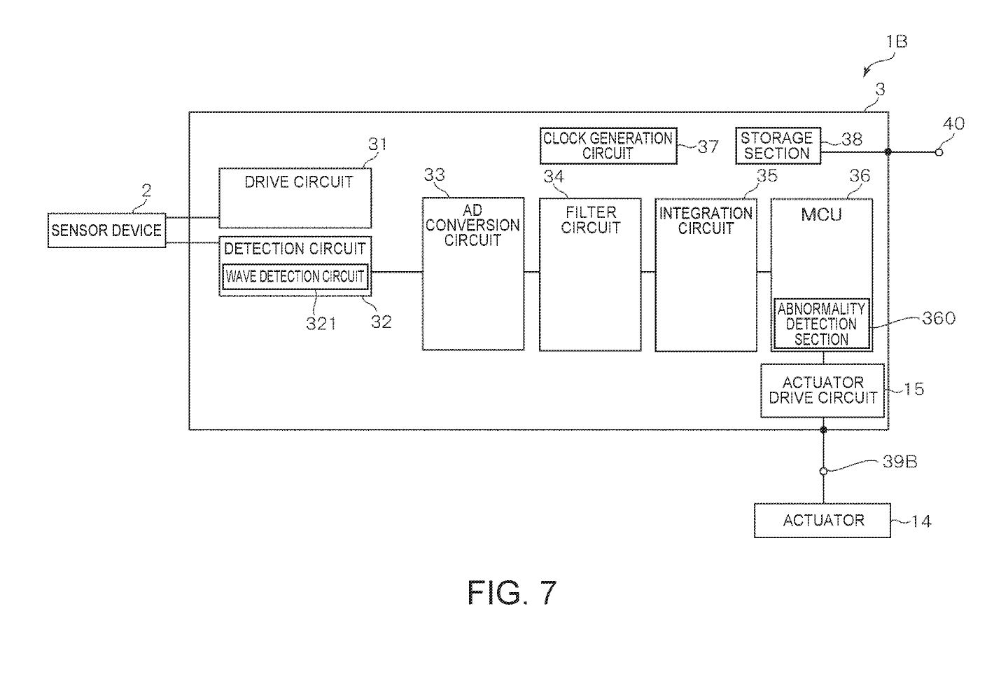

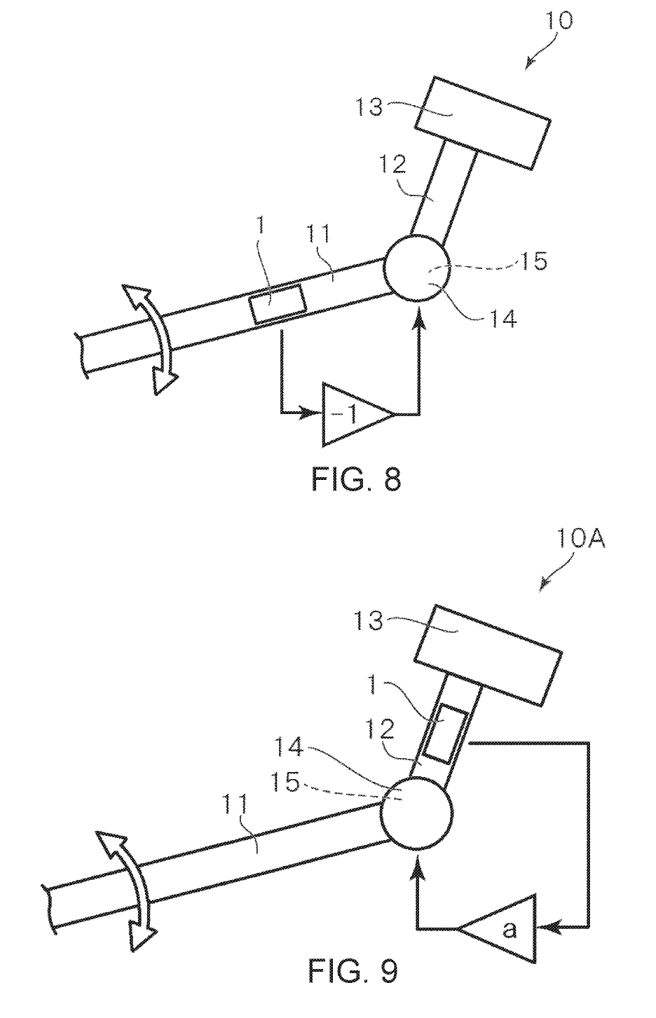

FIG. 8 is a conceptual diagram showing Example 1 of the configuration of the attitude control system including the gyro sensor apparatus according to the embodiment of the invention.

An attitude control system 10 shown in FIG. 8 is a system that reduces vibration of a target object 13 (vibration control system). The attitude control system 10 includes a link 11, which is fixed to a base mount that is not shown, a link 12, which is pivotably linked to the link 11, the target object 13, which is attached to the link 12, the actuator 14, such as a motor, which produces drive force that causes the link 12 to pivot relative to the link 11, the actuator drive circuit 15 which drives the actuator 14 and the gyro sensor apparatus 1 (or 1B), which is attached to the link 11 and controls the drive operation of the actuator drive circuit 15.

In the attitude control system 10, the gyro sensor apparatus 1, when it receives angular velocity due to vibration, controls the drive operation of the actuator 14 (open loop control) in such a way that the angle obtained by integration of the angular velocity over time is canceled. The vibration of the target object 13 can thus be reduced (controlled).

The attitude control system 10 described above includes the gyro sensor apparatus 1 (or 1B) and the actuator 14, which is controlled and driven by the gyro sensor apparatus 1 (or 1B). According to the thus configured attitude control system 10, the responsiveness of the attitude control can be improved.

### Configuration Example 2

FIG. 9 is a conceptual diagram showing Example 2 of the configuration of the attitude control system including the gyro sensor apparatus according to the embodiment of the invention.

An attitude control system 10A shown in FIG. 9 is the same as the attitude control system 10 in Configuration Example 1 described above except that the gyro sensor apparatus 1 (or 1B) is installed in a different position and controlled by a different method. In the attitude control system 10A, the gyro sensor apparatus 1 is attached to the link 12, and the gyro sensor apparatus 1, when it receives angular velocity due to vibration, controls the drive operation of the actuator 14 (closed loop control) in such a way that the angle obtained by integration of the angular velocity over time is constant. The vibration of the target object 13 can thus also be reduced (controlled).

The attitude control system 10A described above can also provide the same effects as those provided by the attitude control system 10.

### Configuration Example 3

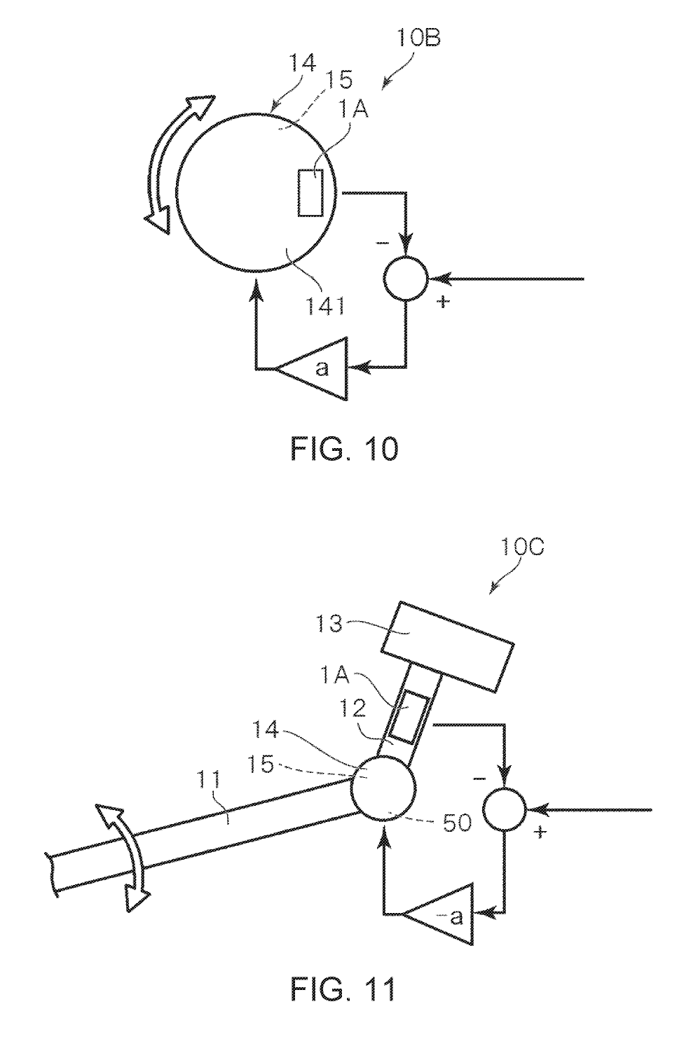

FIG. 10 is a conceptual diagram showing Example 3 of the configuration of the attitude control system including the gyro sensor apparatus according to the embodiment of the invention.

An attitude control system 10B shown in FIG. 10 is a system that controls the actuator 14, which is a motor, in such a way that a rotor 141 of the actuator 14 has a set rotational angle (or set rotational speed). The attitude control system 10B includes the actuator 14, the actuator drive circuit 15, and the gyro sensor apparatus 1A, which is attached to the rotor 141 of the actuator 14. The set rotational angle (or set rotational speed) is inputted as the control information to the gyro sensor apparatus 1A.

In the attitude control system 10B, the gyro sensor apparatus 1A compares the angle (or angular velocity) obtained by integration of the detected angular velocity over time with the set rotational angle (or set rotational speed) and controls the drive operation of the actuator 14 in accordance with the difference between the angle and the set rotational angle (or angular velocity). The rotor 141 thus has the set rotational angle (or rotational speed).

The attitude control system 10B described above can also provide the same effects as those provided by the attitude control system 10.

### Configuration Example 4

FIG. 11 is a conceptual diagram showing Example 4 of the configuration of the attitude control system including the gyro sensor apparatus according to the embodiment of the invention.

An attitude control system 10C shown in FIG. 11 is a system that controls the target object 13 in such a way that the target object 13 has a set position or attitude and is the same as the attitude control system 10A in Configuration Example 2 except that the gyro sensor apparatus 1 (or 1B) is replaced with the gyro sensor apparatus 1A and the gyro sensor apparatus is controlled differently. In the attitude control system 10C, a gyro sensor 50 is attached to the rotor of the actuator 14, and the gyro sensor apparatus 1A is attached to the link 12. A set rotational angle is inputted as the control information to the gyro sensor apparatus 1A. The gyro sensor apparatus 1A, when it receives angular velocity due to vibration, compares the angle obtained by integration of the angular velocity over time with the set rotational angle and controls the drive operation of the actuator 14 in accordance with the difference between the angle and the set rotational angle. The target object 13 thus has a desired attitude.

The attitude control system 10C described above can also provide the same effects as those provided by the attitude control system 10.

### 3. Camera Apparatus

A camera apparatus including any of the attitude control systems described above will be described below as the camera apparatus according to an embodiment of the invention. In the following description, differences from the embodiments described above will be primarily described, and no description of similar items will be made.

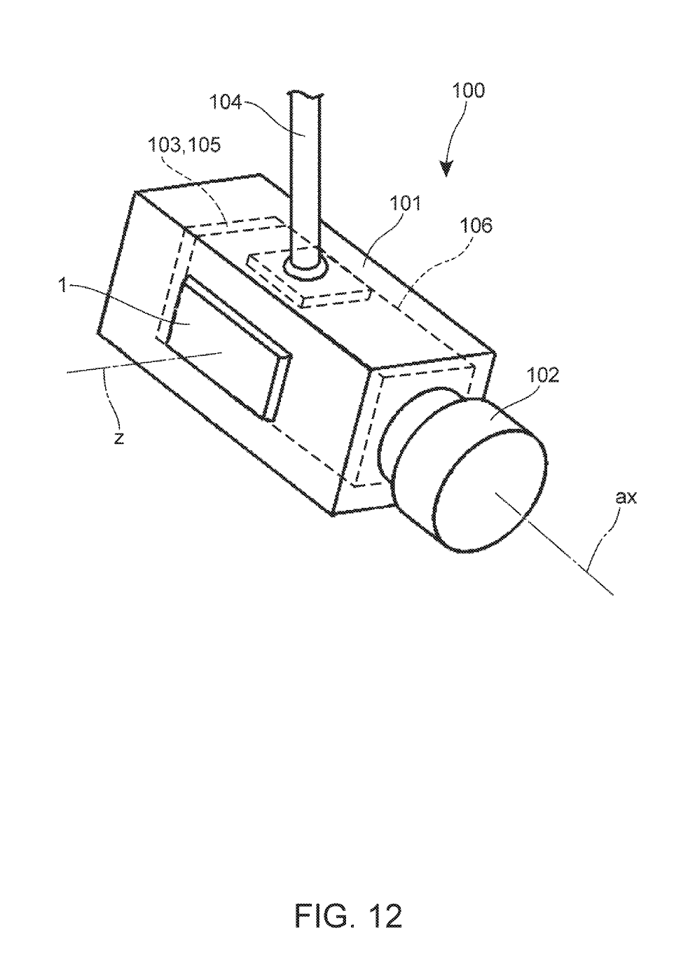

FIG. 12 is a schematic view showing an example of the configuration of the camera apparatus including the gyro sensor apparatus according to the embodiment of the invention.

A camera apparatus 100 shown in FIG. 12 includes an enclosure 101, an imaging unit 106, which is an imaging section including an optical lens unit 102 and an imaging device 103, such as a charge coupled device (CCD), the gyro sensor apparatus 1 (or 1A, 1B) a rod-shaped support member 104, which supports the enclosure 101, an image processor 105, which processes captured image data from the imaging device 103, the actuator 14, and the actuator drive circuit 15.

The gyro sensor apparatus 1 is so disposed that the detection axis thereof (z axis) intersects (at right angles, for example) the optical axis of the imaging unit 106, that is, an optical axis ax of the optical lens unit 102. The optical lens unit 102 and the imaging device 103 are supported by a unit frame which is not shown but the attitude of which can be changed by the actuator 14 relative to the support member 104 to form the imaging unit 106.

The thus configured camera apparatus 100, when the gyro sensor apparatus 1 receives angular velocity due to vibration, controls the drive operation of the actuator 14 based on the angular velocity in such a way that a change in a captured image due to the vibration is canceled to change the attitude of the imaging section relative to the support member 104. What is called image shake correction can thus be performed. The image processor 105 uses the signal from the gyro sensor apparatus 1 (angle information, for example) to perform image processing on the captured image data from the imaging device 103 in such a way that a change in a captured image due to the vibration is canceled.

The camera apparatus 100 described above includes the gyro sensor apparatus 1 (or 1A, 1B), the actuator 14, which is controlled and driven by the gyro sensor apparatus 1, and the imaging unit 106, which is the imaging section, the attitude of which is changed by the actuator 14 relative to the support member 104. According to the thus configured camera apparatus 100, excellent image shake correction can be achieved. The present embodiment has been described with reference to the case where the attitude of the imaging unit 106, which is formed of the optical lens unit 102 and the imaging device 13, which form the imaging section, and the unit frame, which supports the optical lens unit 102 and the imaging device 103, is changed. Instead, only the attitude of a lens that is part of the optical lens unit 102 in the imaging section may be changed, or the position of the imaging device 103 may be changed.

The camera apparatus 100 includes the imaging device 103, which outputs captured image data, and the image processor 105, which processes the captured image data by using the signal from the gyro sensor apparatus 1. The performance of image shake correction can thus be further enhanced.

The gyro sensor apparatus, the attitude control system, and the camera apparatus according to the embodiments of the invention have been described above with reference to the drawings, but the invention is not limited thereto, and the configuration of each portion can be replaced with an arbitrary portion configured to have the same function. Further, any other arbitrarily configured portion may be added to the embodiments of the invention. Moreover, in the invention, arbitrary two or more configurations (features) of the embodiments (variations, configuration examples) described above may be combined with each other.

Further, the above-mentioned embodiments have been described with reference to the case where the device element of the sensor device is made of a piezoelectric material, but the device element may instead be made of silicon, quartz, or any other non-piezoelectric material. In this case, for example, a piezoelectric device may be provided on a base body made of a non-piezoelectric material. Further, in this case, a device element made of silicon is allowed to have excellent vibration characteristics at a relatively low cost. Further, a known micro-processing technology can be used to form the device element with high dimensional precision in an etching process. The size of the device element can therefore be reduced.

Further, the above-mentioned embodiments have been described with reference to the case where the piezoelectric drive method using the reverse piezoelectric effect is used as the method for driving the device element, but not necessarily in the invention. For example, an electrostatic drive method using electrostatic attraction, an electromagnetic drive method using electromagnetic force, and other methods can be used. Similarly, the above-mentioned embodiments have been described with reference to the case where the piezoelectric detection method using the piezoelectric effect is used as the detection method carried out by the device element, but not necessarily in the invention. For example, a capacitance detection method for detecting capacitance, a piezoelectric resistance detection method for detecting piezoelectric resistance, an electromagnetic detection method for detecting induced electromotive force, an optical detection method, and other methods can be used. Further, an arbitrary combination of the methods described above can be used as the drive method and the detection method.

The shape of the device element of the sensor device is not limited to the shape described above, and the shape of any of a variety of known sensor devices can be used. For example, the above-mentioned embodiments have been described with reference to the case where the detection vibration arms are so provided as to be separate from the drive vibration arms, but not necessarily, and the drive vibration arms may also serve as the detection vibration arms.

What is claimed is:

1. A gyro sensor apparatus comprising:
a sensor device that outputs a detection signal;
a control circuit including an angular velocity detection circuit that detects angular velocity based on the detection signal, an angle calculation circuit that calculates an angle based on the angular velocity, and an actuator drive signal generation circuit that generates an actuator drive signal based on the angle, the actuator drive signal being usable to control an actuator drive circuit that drives an actuator;
a base body that supports the sensor device and the control circuit; and
an output terminal that is provided as part of the base body and outputs the actuator drive signal or a signal based on the actuator drive signal.

2. The gyro sensor apparatus according to claim 1, wherein an operation frequency of the angle calculation circuit is equal to an operation frequency of the actuator drive signal generation circuit.

3. The gyro sensor apparatus according to claim 1, wherein the actuator is a rotational stepper motor.

4. The gyro sensor apparatus according to claim 1, wherein the actuator is a DC motor or an AC motor.

5. The gyro sensor apparatus according to claim 1, further comprising:
an input terminal to which control information used to control the actuator is inputted; and
a storage section that stores the control information,
wherein the actuator drive signal generation circuit uses the control information to generate the actuator drive signal.

6. The gyro sensor apparatus according to claim 1, wherein the control circuit further includes an extraction section that extracts angular velocity that belongs to a partial frequency band from the angular velocity detected by the angular velocity detection circuit.

7. The gyro sensor apparatus according to claim 1, wherein the control circuit further includes an abnormality detection section that detects abnormality in an operation state of the actuator based on the detection signal.

8. The gyro sensor apparatus according to claim 1, wherein the control circuit further includes the actuator drive circuit.

9. An attitude control system comprising:
the gyro sensor apparatus according to claim 1; and
an actuator controlled and driven by the gyro sensor apparatus.

10. A camera apparatus comprising:
the gyro sensor apparatus according to claim 1;
an actuator controlled and driven by the gyro sensor apparatus; and
an imaging section an attitude of which is changed by the actuator relative to a support member.

11. The camera apparatus according to claim 10,
wherein the imaging section includes an imaging device that outputs captured image data, and
the camera apparatus further comprises an image processor that processes the captured image data by using a signal from the gyro sensor apparatus.
